(19) United States
(12) Patent Application Publication
(10) Pub. No.: US 2026/0142116 A1
(43) Pub. Date: May 21, 2026

(54) X-RAY WINDOWS, X-RAY TUBES, AND METHODS OF MANUFACTURE

(71) Applicant: VAREX IMAGING CORPORATION, Salt Lake City, UT (US)

(72) Inventors: Vance Scott Robinson, South Jordan, UT (US); David Kirkham, South Jordan, UT (US); Jacob Riggle, Bountiful, UT (US)

(21) Appl. No.: 19/375,763

(22) Filed: Oct. 31, 2025

Related U.S. Application Data
(60) Provisional application No. 63/721,196, filed on Nov. 15, 2024.

(51) Int. Cl. H01J 35/18; H01J 35/08

(52) U.S. Cl. CPC H01J 35/18; H01J 35/08; H01J 2235/08; H01J 2235/122

(57) ABSTRACT

X-ray windows formed from improved materials and having improved cooling, x-ray tubes including the x-ray windows, and methods of manufacturing the x-ray windows and x-ray tubes are disclosed. An x-ray tube can include a cathode, an anode, an enclosure body at least partially surrounding the cathode and the anode, and an x-ray window. The x-ray window can include a radiolucent portion configured to transmit x-rays from the enclosure body. The radiolucent portion can be directly bonded to a radiopaque portion of the x-ray window or the enclosure body by metal-to-metal bonds.

CROSS REFERENCE TO RELATED APPLICATION(S)

This application claims priority to U.S. Provisional Application No. 63/721,196 filed 15 November 2024, the entire disclosure of which is hereby incorporated by reference.

### FIELD

The disclosure relates generally to x-ray tubes and x-ray windows for x-ray tubes, and more particularly, to x-ray windows for x-ray tubes joined to enclosures with improved processes, formed from inexpensive and easily manufacturable materials, and/or featuring improved cooling.

### BACKGROUND

X-ray tubes are tools that are used in a wide variety of applications, both industrial and medical. An x-ray tube typically includes a cathode assembly and an anode positioned within an evacuated enclosure. The cathode assembly includes an electron source, and the anode includes a target surface that is oriented to receive electrons emitted by the electron source. During operation of the x-ray tube, an electric current is applied to the electron source, which causes electrons to be produced by thermionic emission. The electrons are accelerated toward the target surface of the anode by applying a high voltage potential between the cathode assembly and the anode. When the electrons strike the anode target surface, the kinetic energy of the electrons causes the production of x-rays. The x-rays are produced omnidirectionally, and a portion of the x-rays exits the x-ray tube through a window in the x-ray tube. The x-rays that exit the x-ray tube interact with a material sample, patient, or other object and a remainder of the x-rays that do not exit the x-ray tube are absorbed by other structures of the x-ray tube.

Multi-beam x-ray systems use a plurality of electron emitters to generate x-rays at a plurality of focal points. X-ray tubes with enlarged x-ray windows can be used to accommodate larger fields of x-rays generated by multi-beam x-ray systems. X-ray tubes typically use beryllium as a material for the x-ray window. However, beryllium is a scarce and expensive material, and using beryllium for x-ray windows becomes increasingly prohibitive as x-ray window size increases. Further, in some x-ray tubes, an anode can be maintained at a ground potential. This can result in electrons scattered after hitting the anode target surface hitting the x-ray window and increasing the temperature at the x-ray window.

### SUMMARY

An aspect of the present disclosure relates to an x-ray tube including a cathode, an anode, an enclosure body at least partially surrounding the cathode and the anode, and an x-ray window. The x-ray window can include a radiolucent portion configured to transmit X-rays from the enclosure body. The radiolucent portion can be directly bonded to a radiopaque portion of the X-ray window or the enclosure body by metal-to-metal bonds.

In one or all examples, the radiolucent portion can include a first material different from a second material of the radiopaque portion. In one or all examples, the first material can include aluminum and the second material can include steel. In one or all examples, the enclosure body can include the second material and the radiopaque portion can be welded to the enclosure body.

In one or all examples, the radiolucent portion can curve inwardly relative to the enclosure body. In one or all examples, the x-ray window can include a carbon nanotube coating on a surface of the x-ray window.

Another aspect of the present disclosure relates to an x-ray window including a radiolucent portion, a radiopaque portion, and a cooling channel embedded within the x-ray window.

In one or all examples, the cooling channel can traverse an entire area of the radiolucent portion. In one or all examples, the cooling channel can be disposed in the radiopaque portion. In one or all examples, the cooling channel can encircle the radiolucent portion.

In one or all examples, the radiolucent portion can include a first material, the radiopaque portion can include a second material different from the first material, and the cooling channel can be defined between the first material and the second material. In one or all examples, a first material of the radiolucent portion can be bonded to a second material of the radiopaque portion by direct metal-to-metal bonds. In one or all examples, the first material can be different from the second material.

In yet another aspect of the present disclosure, a method for manufacturing an x-ray tube includes directly bonding a first material of a radiolucent portion to a second material of a radiopaque portion. An x-ray window of the x-ray tube can include the radiolucent portion. An enclosure body of the x-ray tube or the x-ray window can include the radiopaque portion.

In one or all examples, the first material can be directly bonded to the second material by diffusion bonding, explosion bonding, ultrasonic welding, or friction welding. In one or all examples, the method can further include bonding the x-ray window to the enclosure body. The enclosure body can include the second material. In one or all examples, the x-ray window can be bonded to the enclosure body by tig welding, laser welding, or conventional welding.

In one or all examples, the first material can be different from the second material. In one or all examples, the method can further include forming the radiolucent portion by removing the second material to expose the first material in the radiolucent portion. In one or all examples, the method can further include bonding a U-joint between the x-ray window and the enclosure body.

In a still further aspect of the present disclosure, an anode assembly includes a target configured to generate x-rays in response to an electron beam impinging on the target, a hood configured to contain scattered electrons, and an x-ray window non-hermetically coupled to the hood.

In one or all examples, the x-ray window can include a first material different from a second material of the hood. In one or all examples, the first material can include aluminum, titanium, graphite, copper, alumina, beryllium, beryllia, or diamond. In one or all examples, the second material can include steel, copper, or aluminum.

In one or all examples, the x-ray window can be coupled to the hood by a retaining ring. In one or all examples, the x-ray window can be coupled to the hood by spot welds, spikes, swaging, or brazing.

### BRIEF DESCRIPTION OF THE DRAWINGS

The written disclosure herein describes illustrative embodiments that are non-limiting and non-exhaustive. Reference is made to certain of such illustrative embodiments that are depicted in the figures, in which:

FIG. 1 is a perspective view of an imaging system.

FIG. 2 is a cross-sectional view of an x-ray tube.

FIG. 3 is a side view of an x-ray window assembly.

FIG. 4 is a cut-away perspective view of an x-ray window.

FIG. 5 is a cut-away perspective view of a material used to form the x-ray window of FIG. 4.

FIG. 6 is a cross-sectional view of an x-ray window joined to an enclosure through a U-joint.

FIG. 7 is a perspective view of an x-ray window with a cooling channel.

FIG. 8 is a side view of the x-ray window of FIG. 7.

FIG. 9 is a cross-sectional side view of the x-ray window of FIG. 7.

FIG. 10 is a cut-away perspective view of an x-ray window with a cooling channel.

FIG. 11 is a cut-away, cross-sectional perspective view of the x-ray window of FIG. 10.

FIG. 12 is a cut-away perspective view of an anode and a portion of an x-ray tube.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The disclosure relates generally to radiological imaging systems, including x-ray sources, computed tomography (CT) scanners, high voltage or other electrical connectors, and related components thereof. Representative applications include, but are not limited to, imaging, medicine, diagnostics, radiology, radiotherapy, radiography and tomography, food irradiation and a range of security and industrial x-ray technologies.

A multi-beam x-ray tube is a type of x-ray tube capable of producing multiple x-ray beams from different locations in the same vacuum envelope. A multi-beam x-ray tube typically includes an array of electron sources that are independently controlled to generate multiple focused electron beams. The electron beams are directed by a voltage potential difference from a cathode to one or more target points on an anode. When the electron beams strike the target points on the anode, the kinetic energy of the electrons produce multiple x-ray beams. The x-ray beams can be directed towards a material sample, a patient, another object, or the like at different angles. Providing multiple x-ray beams at different angles can be used to collect a series of x-ray projections from multiple perspectives, which can enable three-dimensional image reconstruction (e.g., for tomosynthesis or tomographic imaging). Multi-beam x-ray sources provide higher fidelity reconstructions of objects than other stationary three-dimensional imaging systems because the distance between neighboring focal spots is less than could be achieved with multiple conventional x-ray sources each contained in its own vacuum enclosure. The distance between focal spots is known as the focal spot pitch. The pitch for multi-beam x-ray sources is about 10 mm. The typical pitch for an array of conventional single-emitter x-ray sources is about 100 mm, or about 10 times greater than the focal spot pitch of a multi-beam x-ray source.

X-ray tubes can include an x-ray window through which the x-ray beams are directed from the x-ray tube towards an object. Materials in conventional x-ray windows can be chosen for their low density and low atomic number. Specifically, utilizing materials with low atomic numbers and low density for x-ray windows minimizes the absorption of x-rays by the x-ray window and allows for maximum transmission of x-ray beams through the x-ray window. The x-ray window of an x-ray tube can be a portion of the x-ray tube made from materials that are relatively transparent to x-rays (e.g., referred to as being radiolucent), and conventional materials for x-ray windows can include beryllium, borosilicate glass, aluminum, graphite, diamond, titanium, synthetic materials (e.g., polyimide, dielectric oil, or the like), combinations thereof, and the like.

Multi-beam x-ray tubes create unique impacts and demands on associated x-ray windows. For example, the physical size of x-ray windows in multi-beam x-ray tubes can be larger than conventional x-ray tubes that generate a single x-ray beam, which can be used to accommodate multiple x-ray beams. Conventional x-ray window materials can be expensive and using these materials in large multi-beam x-ray windows can be cost-prohibitive. X-ray windows of x-ray tubes can be formed in an enclosure of an x-ray tube, and a low pressure (e.g., a vacuum, an ultra-high vacuum, or a near vacuum) can be applied to the enclosure. As such, the enclosure and the x-ray window can be formed from materials and bonded, attached, or connected to one another using techniques that can withstand pressure differentials between the environment inside the enclosure and the environment outside the enclosure. Further, x-ray tubes that use rotating anodes can generate significant thermal loads at the x-ray window through scattered electrons hitting the x-ray window. Thus, it is desirable to manufacture x-ray windows from radiolucent, inexpensive materials and with improved thermal conductivity.

The present disclosure addresses these and other challenges by providing improved x-ray windows, x-ray tubes including x-ray windows, and methods of manufacturing x-ray windows and x-ray tubes. The x-ray tubes of the present disclosure can include an x-ray window integral with an enclosure of the x-ray tube and capable of withstanding high thermal loads and pressure differentials, while maintaining, cost-effectiveness, manufacturability, and structural integrity. In one or all examples, an x-ray window can be formed from a radiolucent material, such as aluminum, alumina, titanium, steel, stainless steel, iron, nickel, chrome, copper, beryllium, beryllia, alloys thereof, or the like. In one or all examples, the x-ray window can include non-metal materials, such as diamond, graphite, glass, or the like. The x-ray window can be directly bonded to a material of the enclosure of the x-ray tube. The enclosure can include steel, stainless steel, titanium, copper, ceramic materials, aluminum, alumina, or the like. The material of the x-ray window can be dissimilar to a material of the enclosure and the material of the x-ray window can be directly bonded to the material of the enclosure. The x-ray window can be bonded to the enclosure through any suitable direct metal-to-metal bonding technique, such as diffusion bonding, explosion bonding, ultrasonic welding, friction welding, or the like. In one or all examples, the x-ray window can include cooling channels, which can be used to extract heat from the x-ray window and improve thermal conductivity of the x-ray window. Examples of the present disclosure can be particularly beneficial in the context of multi-beam x-ray tubes; however, the present disclosure is not limited to multi-beam x-ray tubes and the x-ray window and x-ray tube materials, structures, and methods described herein can be applied in various contexts, including single-beam x-ray tubes.

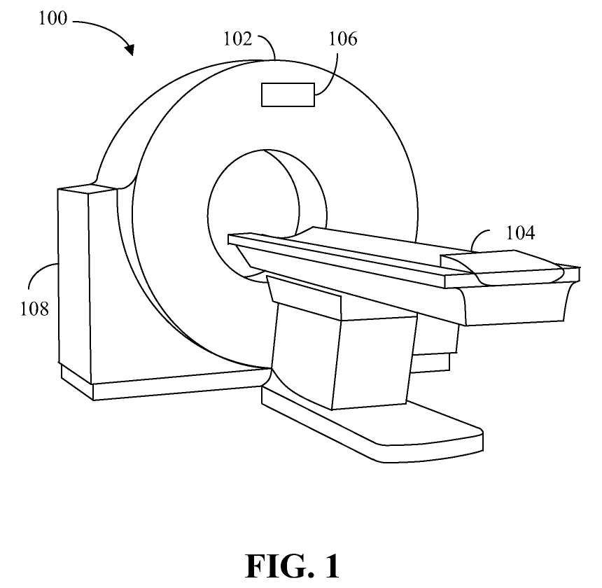

These and other examples are discussed below with reference to FIGS. 1 through 12. However, those skilled in the art will readily appreciate that the detailed description given herein with respect to these Figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 illustrates a perspective view of an imaging system 100. The imaging system 100 can be a system that uses radiation to create images, for example, for medical purposes such as imaging human bodies or body parts. The imaging system 100 can include an x-ray scanner, a computed tomography (CT) scanner, similar imaging devices, or combinations thereof. The imaging system 100 includes a housing 102 for a gantry, a support 104 (e.g., a patient support or table), an imaging apparatus (e.g. , an x-ray tube 106), and a frame 108. The support 104 can be positioned or positionable within the housing 102 in order to support a patient’s body during a scan.

The housing 102 can house various components of the imaging system 100. For example, the housing 102 can house the x-ray tube 106, a heat exchanger, a power supply or generator, other electronic components, and cables. The x-ray tube 106 can include a cable connector retainer assembly to couple the x-ray tube 106 to a high voltage cable that supplies power to the x-ray tube 106 (e.g., by supplying power to the tube within the housing). The housing 102 can also house a detector configured for digital radiography. In one or all examples, such as for CT systems, the x-ray tube 106 and the detector are rotated about the body of the patient, for example, within the housing 102. Although FIG. 1 is directed to an imaging system 100 that can be used to provide imaging in a medical context with a human patient, the present disclosure is directed to x-ray tubes, which can be used in a variety of contexts, such as radiography, mammography, CT, diagnostic, industrial, security, material and structure analysis, or any other applications.

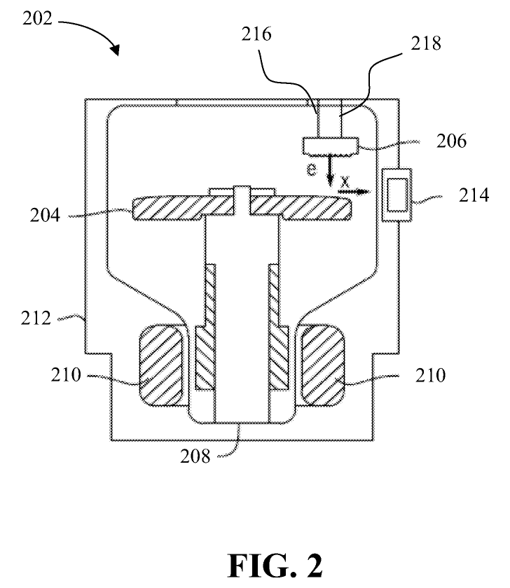

FIG. 2 illustrates a cross-sectional view of an x-ray tube 202. The x-ray tube 202 can be used in an x-ray system or apparatus (e.g., an imaging system or apparatus), such as being used as the x-ray tube 106 in the imaging system 100 of FIG. 1. The x-ray tube 202 can include an anode 204, a cathode 206, a rotor 208, a stator 210, an enclosure body 212, and an x-ray window 214.

An electrical circuit connecting the cathode 206 and the anode 204 can be powered to supply a potential difference between the cathode 206 and the anode 204. For example, power can be delivered to cathode 206 through electrical lines 216, 218. This can generate a stream of electrons e that are directed and accelerated from the cathode 206 towards the anode 204. The stream of electrons e strikes the surface of the anode 204 and produces high frequency electromagnetic waves or x-rays x. The x-rays x can be produced omnidirectionally. X-rays x that strike the x-ray window 214 can be transmitted through the x-ray window 214. X-rays x that strike the enclosure body 212 can be blocked from exiting the x-ray tube 202. As such, the x-ray tube 202 produces x-rays x through the x-ray window 214.

The enclosure body 212 can be formed from radiopaque materials. The x-ray window 214 can be formed from radiolucent materials. Specifically, the x-ray window 214 can be formed from materials that allow x-rays x with desired wavelengths, frequencies, energy, and the like to pass through the x-ray window 214, while blocking other wavelengths, frequencies, energy, and the like. In order to provide desired transmission properties in the enclosure body 212 and the x-ray window 214, the enclosure body 212 and the x-ray window 214 can be formed from different materials and/or with different thicknesses. For example, the enclosure body 212 can be formed from metals, such as steel, stainless steel, titanium, copper; ceramic materials; alumina; or the like. The enclosure body 212 and the x-ray window 214 can be formed from the same or dissimilar materials.

In one or all examples, the x-ray window 214 can be formed from materials that are relatively cheap, have good x-ray transmittance, and have low outgassing. This can reduce costs of x-ray tubes. A thickness of the x-ray window 214 can be selected to allow for transmittance of x-rays with certain wavelengths, frequencies, energy, and the like. The x-ray window 214 can define at least a portion of the vacuum enclosure of the x-ray tube 202 and using materials with low out-gassing aid in maintaining an ultra-high vacuum within the vacuum enclosure. The x-ray window 214 can be formed from metals, such as aluminum, alumina, titanium, steel, stainless steel, iron, nickel, chrome, copper, beryllium, beryllia, alloys thereof, or the like. In one or all examples, the x-ray window 214 can include non-metal materials, such as diamond, graphite, glass, ceramic materials, alumina, or the like. In one or all examples, the x-ray window 214 can have a thickness in a range from about 0.2 mm to about 2.5 mm; however, any suitable thickness can be used for the x-ray window 214, depending on the application of the x-ray tube 202. The x-ray window 214 can have any suitable area. For example, the x-ray window 214 can have an area in a range from about 2 cm by 10 cm to about 1.5 cm by 80 cm. However, the x-ray window 214 can have any suitable area depending on the application of the x-ray tube 202. For example, multi-beam x-ray tubes can have x-ray windows with relatively large areas and single-beam x-ray tubes can have x-ray windows with relatively small areas. The materials and methods of the present disclosure can be applied to x-ray windows and x-ray tubes for any applications.

In one or all examples, edges or corners of the x-ray window 214 can have radiuses in a specified range or greater than specified values. This can provide additional strength to the x-ray window 214 and conformity (e.g. , in response to thermal expansion) between the x-ray window 214 and the enclosure body 212. For example, corners of the x-ray window 214 can have radiuses in a range from about 1 mm to about 2 mm. The corners of the x-ray window 214 can have radiuses greater than about 0.5 mm, greater than about 1 mm, or greater than about 2 mm.

In one or all examples, a coating or filter can be applied on the x-ray window 214. In one or all examples, the coating or filter can be removable and replaceable, and can be provided on an exterior surface of the x-ray window 214, outside of the vacuum enclosure. In one or all examples, the coating can include carbon nanotubes, which can increase heat transfer from the x-ray window 214 and provide cooling of the x-ray window 214.

The enclosure body 212 and the x-ray window 214 can define a vacuum enclosure of the x-ray tube 202. For example, a vacuum or near vacuum (e.g., an ultra-high vacuum) can be applied within the volume of the enclosure body 212 and the x-ray window 214. As such, the enclosure body 212 and the x-ray window 214 can be configured to withstand a pressure differential between the inner volume of the enclosure body 212 and the x-ray window 214 and an ambient environment of the x-ray tube 202.

Because the enclosure body 212 and the x-ray window 214 can be formed from dissimilar materials, the enclosure body 212 and the x-ray window 214 can be formed or manufactured separately and subsequently joined or bonded to one another. The enclosure body 212 and the x-ray window 214 can be bonded to one another using techniques that can withstand the pressure differential between the inner volume of the enclosure body 212 and the x-ray window 214 and the ambient environment of the x-ray tube 202. The enclosure body 212 and the x-ray window 214 can be bonded to one another using various direct bonding techniques that allow for material of the x-ray window 214 (e.g., metal material, such as aluminum) to be directly bonded to material of the enclosure body 212 (e.g., metal material, such as stainless steel), even in examples in which the materials of the x-ray window 214 are dissimilar to materials of the enclosure body 212. For example, x-ray window 214 can be bonded to the enclosure body 212 through metal-to-metal bonding, such as diffusion bonding, explosion bonding, ultrasonic welding, friction welding, or the like.

In one or all examples, the x-ray window 214 can include a radiopaque portion and a radiolucent portion. The radiopaque portion and the radiolucent portion can include the same materials with different thicknesses or can include different materials. In examples in which the radiopaque and radiolucent portions include varied materials, the different materials can be joined to one another through any of the above-described direct metal-to-metal bonding techniques. The radiopaque and radiolucent portions can be provided with different materials such that dissimilar metal bonding techniques can be used to bond the radiolucent portion to the radiopaque portion and conventional metal bonding techniques can be used to bond the radiopaque portion to the enclosure body 212.

For example, the radiolucent portion can include a first metal material. The radiopaque portion can surround the radiolucent portion (e.g., the radiopaque portion can encircle the radiolucent portion) and can include a second metal material different from the first metal material. The enclosure body 212 can also include the second metal material. The radiolucent portion can be bonded to the radiopaque portion using a direct metal-to-metal bonding technique for joining dissimilar metals, such as diffusion bonding, explosion bonding, ultrasonic welding, friction welding, or the like. The radiopaque portion of the x-ray window 214 can be bonded to the enclosure body 212 by a bonding technique for joining similar materials, which may be a conventional bonding technique, such as tig welding, laser welding, conventional welding, or the like.

In one or all examples, the x-ray tube 202 can be a multi-beam x-ray tube. The x-ray tube 202 can include a plurality of cathodes 206, which each produce a stream of electrons e directed towards the anode 204. Each of the cathodes 206 can have a focal point on the anode 204 and the x-ray tube can generate a plurality of x-ray beams from each focal point on the anode 204. In one or all examples, the x-ray tube 202 can be a rotating anode-type x-ray tube and the rotor 208 can rotate the anode 204 relative to the stator 210 and the enclosure body 212.

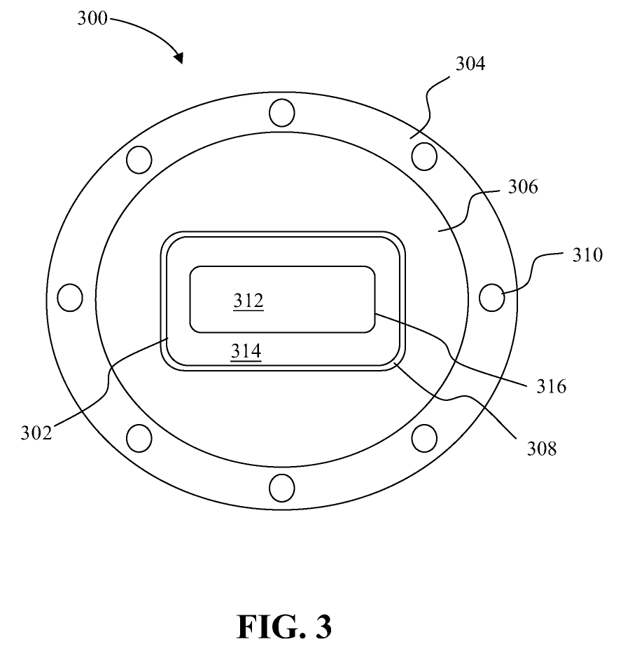

FIG. 3 illustrates a side view of an x-ray window assembly 300 including an x-ray window 302. The x-ray window 302 can be used as the x-ray window 214 in the x-ray tube 202 of FIG. 2. The window assembly 300 can include an attachment portion 304 for attaching x-ray window 302 to an enclosure body of an x-ray tube.

In one or all examples, the window assembly 300 can form at least a portion of the enclosure body of an x-ray tube. For example, the attachment portion 304 can include a radiopaque portion 306 surrounding the x-ray window 302 and the radiopaque portion 306 can form at least a portion of the enclosure body of an x-ray tube. The radiopaque portion 306 of the attachment portion 304 be bonded to the x-ray window 302 at a bond 308. The attachment portion 304 can further include fastening holes 310 for attaching the window assembly 300 to an enclosure body of an x-ray tube or a portion of the enclosure body other than the window assembly 300. In one or all examples, the window 302 can be attached directly to an enclosure body of an x-ray tube and the fastening holes 310 can be omitted.

The x-ray window 302 can include a radiolucent portion 312 and a radiopaque portion 314. In one or all examples, the radiolucent portion 312 can be bonded to the radiopaque portion 314 at a bond 316. In one or all examples, the radiolucent portion 312 and the radiopaque portion 314 can be a monolithic piece or a unitary component. The radiopaque portion 314 can surround a periphery of the radiolucent portion 312. In other words, the radiopaque portion 314 can encircle the radiolucent portion 312. In one or all examples, the radiopaque portion 314 can be part of an enclosure of an x-ray tube, such that the radiolucent portion 312 is directly bonded to the enclosure at the bond 316.

The radiolucent portion 312 and the radiopaque portion 314 can be formed from different thicknesses of the same material. For example, the radiolucent portion 312 and the radiopaque portion 314 can be formed from a metal or other material with the radiolucent portion 312 having a reduced thickness relative to the radiopaque portion 314. For example, the radiolucent portion 312 and the radiopaque portion 314 can be formed from stainless steel, titanium, aluminum, or the like, and the radiolucent portion 312 can be milled to have a reduced thickness relative to the radiopaque portion 314. In one or all examples, the x-ray window 302 can include a multi-layer material and additional layers of material can be removed from the radiolucent portion 312 relative to the radiopaque portion 314. For example, the x-ray window 302 can include layers of stainless steel and aluminum. The stainless steel can be removed from the radiolucent portion 312 and the radiopaque portion 314 portion can include the stainless steel and aluminum layers.

The x-ray window 302 can include one or more materials. The x-ray window 302 can be formed from metals, such as aluminum, alumina, titanium, steel, stainless steel, iron, nickel, chrome, copper, beryllium, beryllia, alloys thereof, or the like. The x-ray window 302 can be formed from non-metals, such as ceramic materials, graphite, diamond, glass, alumina, or the like. The radiolucent portion 312 and the radiopaque portion 314 can be formed from the same or different materials. For example, the radiopaque portion 314 can be formed from metals, such as steel, stainless steel, titanium, copper, aluminum; ceramic materials; alumina; or the like. The radiolucent portion 312 can be formed from metals, such as aluminum, alumina, titanium, steel, stainless steel, iron, nickel, chrome, copper, beryllium, beryllia, alloys thereof, or the like. In one or all examples, the radiolucent portion 312 can include non-metal materials, such as diamond, graphite, glass, ceramics, alumina, or the like. In one or all examples, the x-ray window 302 can include a coating on the radiolucent portion 312 and/or the radiopaque portion 314. For example, a carbon nanotube coating can be included on the radiolucent portion 312 and/or the radiopaque portion 314, which can be used to increase heat transfer between the x-ray window 302 and surroundings thereof.

In one or all examples, the radiolucent portion 312 can have a sufficient thickness to attenuate low-dose x-rays. In other words, the radiolucent portion 312 is not radiotransparent, and can be of a sufficient thickness to account for the minimum filtration requirements for low-dosage x-rays. This can include compliance with FDA requirements. For example, the radiolucent portion 312 can be aluminum can have a thickness of about 2.5 mm or greater. In one or all examples, the radiolucent portion 312 can be aluminum having a thickness in a range from about .3 mm to about 5.4 mm.

In one or all examples, the bond 316 can be a direct bond between dissimilar materials, and the bond 308 can be a bond between similar materials. For example, the radiolucent portion 312 can include a material different from the radiopaque portion 314. The bond 316 can be a direct bond, such as a metal-to-metal direct bond between the radiolucent portion 312 and the radiopaque portion 314. Bonding techniques used for the bond 316 can include diffusion bonding, explosion bonding, ultrasonic welding, friction welding, or the like. The bond 308 can be a bond between similar materials (e.g., the radiopaque portion 314 can include the same or similar radiopaque materials to the radiopaque portion 306 or an enclosure of an x-ray tube), which can include tig welding, laser welding, conventional welding, or the like.

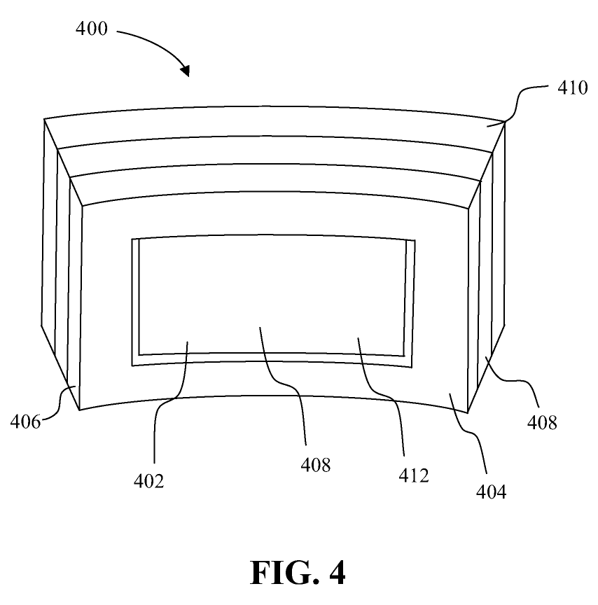

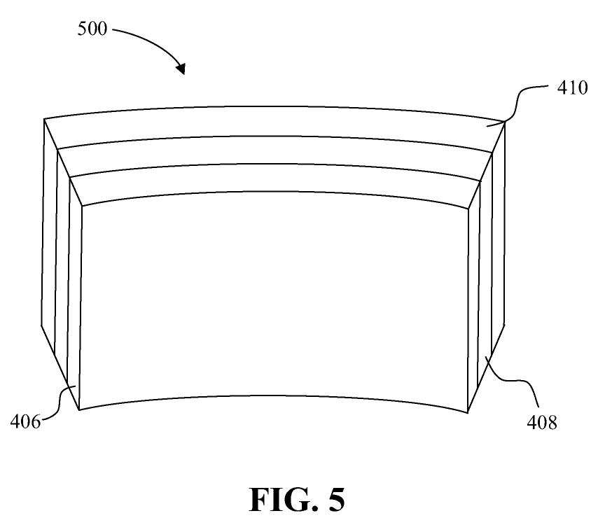

FIGS. 4 and 5 illustrates cut-away perspective views of an x-ray window 400. The x-ray window 400 can be used as the x-ray window 302 of FIG. 3, the x-ray window 214 of FIG. 2, or the like. The x-ray window 400 can include a radiolucent portion 402 and radiopaque portion 404. The radiopaque portion 404 can surround or encircle the radiolucent portion 402.

In the example of FIGS. 4 and 5, the x-ray window 400 includes a three-layer structure. The x-ray window 400 can include an outer layer 406, an inner layer 408, and an outer layer 410. The inner layer 408 can be formed from a material dissimilar to the outer layers 406, 410. For example, the inner layer 408 can be formed from a first metallic material (e.g., aluminum) and the outer layers 406, 410 can be formed from a second metallic material (e.g., stainless steel). The outer layers 406, 410 can be formed from the same or different materials relative to one another. The inner layer 408 can be bonded to the outer layers 406, 410 using any of the direct bonding techniques described herein, such as metal-to-metal direct bonding techniques. Bonding techniques used to bond the inner layer 408 to each of the outer layers 406, 410 can include diffusion bonding, explosion bonding, ultrasonic welding, friction welding, or the like.

As illustrated in FIG. 4, the inner layer 408 can define the radiolucent portion 402. The first metallic material used to form the inner layer 408 can be a relatively radiotransparent material, which allows desired x-rays generated in an x-ray tube to be transmitted through the inner layer 408 in the radiolucent portion 402. In one or all examples, the inner layer 408 can be formed from a material different from or dissimilar to a material of an enclosure of an x-ray tube in which the x-ray window 400 is to be positioned. This can limit bonding techniques that can be used to bond the x-ray window 400 to the enclosure. The inner layer 408 can be formed from metals, such as aluminum, titanium, steel, stainless steel, iron, nickel, chrome, copper, beryllium, alloys thereof, or the like.

As further illustrated in FIG. 4, the outer layers 406, 410 can define the radiopaque portion 404. The second metallic material used to form the outer layers 406, 410 can include a relatively radiopaque material. Thus, the outer layers 406, 410 can block incoming x-rays and prevent the x-rays from being transmitted through the x-ray window 400 outside of the radiolucent portion 402. In one or all examples, the outer layers 406, 410 can include materials similar to materials of an enclosure to which the x-ray window 400 will be bonded. This can allow for conventional bonding techniques to be used to bond the x-ray window 400 to the enclosure. For example, the outer layers 406, 410 of the x-ray window 400 can be bonded to the enclosure of an x-ray tube through conventional bonding techniques, such as tig welding, laser welding, conventional welding, or the like. The outer layers 406, 410 can be formed from metals, such as titanium, steel, stainless steel, iron, nickel, chrome, copper, alloys thereof, or the like.

Although the x-ray window 400 is illustrated as including three layers, in one or all examples, the x-ray window 400 can include more or fewer layers. For example, either of the outer layers 406, 410 can be omitted. When one of the outer layers 406, 410 is omitted, the other of the outer layers 406, 410 can be bonded to an enclosure of an x-ray tube using conventional bonding techniques. Any of the layers 406, 408, 410 can be duplicated.

As illustrated in FIG. 5, the x-ray window 400 can be formed by first providing a multi-layer material 500, such as a billet. The multi-layer material 500 includes the layers 406, 408, 410. The radiolucent portion 402 can be formed by removing selected portions of the multi-layer material 500. For example, as illustrated in FIG. 4, the radiolucent portion 402 can be formed by removing an area 412 of the outer layer 406, exposing the inner layer 408. Although not illustrated in FIG. 4, an area of the outer layer 410 similar to or symmetrical to the area 412 can be removed to expose the inner layer 408 through the outer layer 410. Depending on thicknesses of the layers 406, 408, 410 and desired transmissivities to be achieved by the x-ray window 400, portions of the outer layers 406, 410 can remain in the radiolucent portion 402 over the inner layer 408. In one or all examples, portions of the inner layer 408 in the radiolucent portion 402 can also be removed (e.g., a thickness of the inner layer 408 can be reduced in forming the radiolucent portion 402). Portions of the layers 406, 408, 410 can be removed by milling or other subtractive manufacturing techniques.

As illustrated in FIGS. 4 and 5, the x-ray window 400 and the multi-layer material 500 used to form the x-ray window 400 can include a curvature. In one or all examples, the x-ray window 400 can curve inward, with respect to an enclosure of an x-ray tube when the x-ray window 400 is attached thereto. In one or all examples, the x-ray window 400 can curve outward relative to the enclosure. Providing the x-ray window 400 with a curvature (e.g. , as opposed to providing a planar x-ray window) can provide added strength to the x-ray window 400 and can help to maintain the shape of the x-ray window 400, even when a pressure differential is applied between an internal volume of an x-ray tube and an ambient environment. In one or all examples, the curved profile of the x-ray window 400 can allow the x-ray window 400 to move or flex, without buckling, as a pressure differential is applied between the internal volume and the ambient environment. The x-ray window 400 can be provided with wrinkles to build stress concentrations into the x-ray window 400. The x-ray window 400 can be provided with curvature in a single or multiple dimensions.

In one or all examples, a portion of the outer face of outer layers 574, 576 can be machined away to form the x-ray window 414 of FIG. 4. For instance, in one or all examples, an interior area of the outer face 542 of outer layer 534 (and/or layer 536 can be removed), exposing a portion of the material of layer 572 beneath. The exposed portion can become the radiolucent portion of the x-ray window 414 of FIG. 4. The unexposed, or unremoved portion surrounding the interior area or exposed portion can become the radiopaque portion of the x-ray window 414 of FIG. 4.

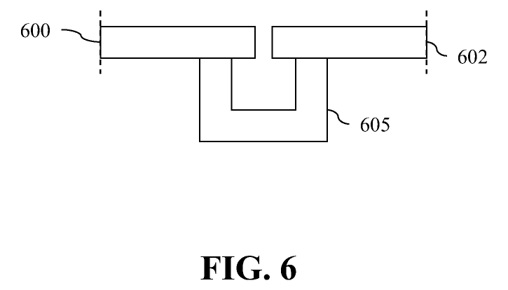

FIG. 6 illustrates a cross-sectional view of an x-ray window 600 joined to an enclosure body 602 through a U-joint 604. The x-ray window 600 can be used as any of the x-ray windows 214, 302, 402, discussed above with respect to FIGS. 2 through 4. The enclosure body 602 can be used as the enclosure body 212 or the radiopaque portion 306, discussed above with respect to FIGS. 2 and 3.

The U-joint 604 can be used to provide compliance (e.g., can be a compliant joint) between the x-ray window 600 and the enclosure body 602. As such, the U-joint 604 can be referred to as a compliant U-joint. The U-joint 604 can relieve stress between the x-ray window 600 and the enclosure body 602, such as stress caused by thermal expansion of the x-ray window 600 and/or the enclosure body 602. In one or all examples, the U-joint 604 can be formed from a metal material having good compliance, such as stainless steel or the like. The U-joint 604 can include materials the same as or different to the x-ray window 600 and the enclosure body 602. In examples in which materials of the U-joint 604 are dissimilar to the x-ray window 600 and/or the enclosure body 602, direct bonding techniques can be used to bond the U-joint 604 to the window 600 and/or the enclosure body 602. For example, any of the direct metal-to-metal bonding techniques described above can be used. In one or all examples, the U-joint 604 can include materials the same as or similar to the x-ray window 600 and/or the enclosure body 602. Thus, the U-joint 604 can be bonded to the x-ray window 600 and/or the enclosure body 602 by a bonding technique for joining similar materials, which may be a conventional bonding technique, such as tig welding, laser welding, conventional welding, or the like.

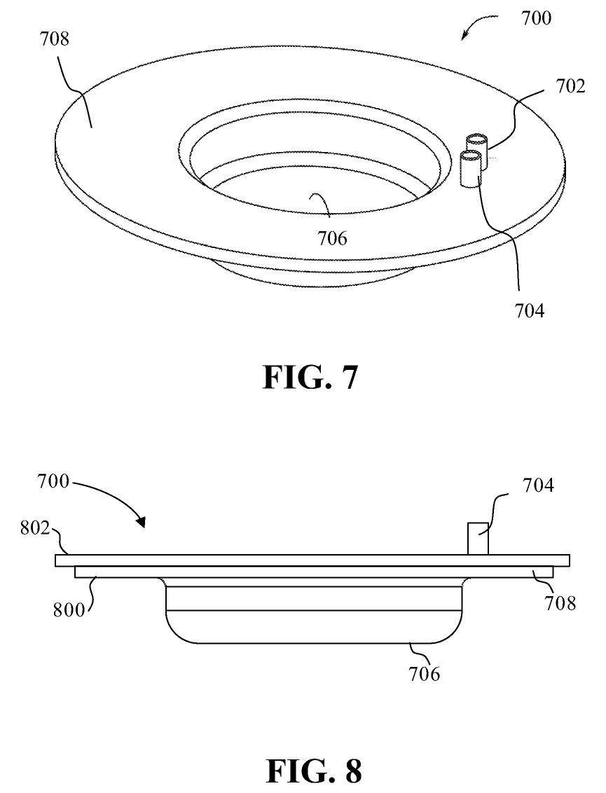

FIGS. 7 through 11 provide examples of x-ray windows that include improved cooling. In one or all examples, x-ray windows and radiolucent portions thereof can be formed from materials having relatively low melting points. Further, in some applications, such as in x-ray tubes that include rotating anodes, the anode can be at a ground potential. This can result in electrons being more likely to scatter and impact the x-ray window and can cause the x-ray window to heat up. As a result, it may be desirable to provide x-ray windows with improved cooling. This avoids problems that can be caused by the x-ray windows overheating. FIGS. 7 through 11 use cooling channels in order to cool the x-ray windows. However, providing cooling channels in a radiolucent portion of an x-ray window can alter the paths of X rays that pass through the x-ray window. This can cause distortion in an image generated based on detection of the X rays that pass through the x-ray window. FIGS. 7 through 11 provide examples of cooling x-ray windows without distorting images generated based on detection of X rays that pass through an x-ray window with cooling channels.

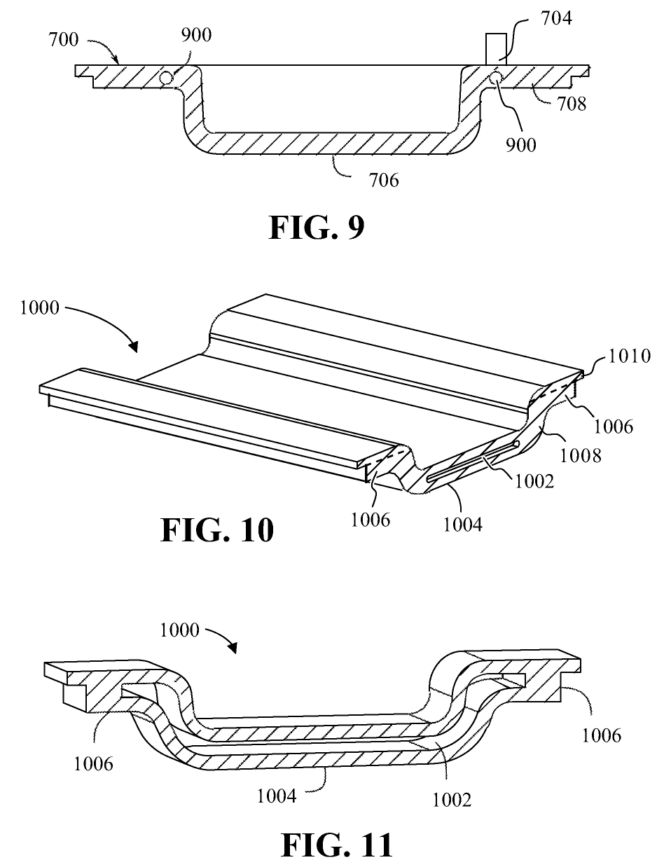

FIGS. 7 through 9 illustrate views of an x-ray window 700 including cooling channels 900. FIG. 7 illustrates a perspective view, FIG. 8 illustrates a side view, and FIG. 9 illustrates a cross-sectional view. The x-ray window 700 can be used as any of the x-ray windows 214, 302, 402, 600, discussed above with respect to FIGS. 2 through 4 and 6. The x-ray window 700 can include cooling channels 900 (illustrated in FIG. 9) that flow from an inlet 702 and to an outlet 704. The x-ray window 700 can include a radiolucent portion 706 configured to transmit X rays and a radiopaque portion 708 configured to block X rays.

FIGS. 7 through 9 illustrate an example in which the cooling channels 900 flow in the radiopaque portion 708 outside of the radiolucent portion 706. By positioning the cooling channels 900 in the radiopaque portion 708 outside of the radiolucent portion 706, the cooling channels 900 do not impact x-rays that are transmitted through the radiolucent portion 706. As such, images based on detected X rays that have passed through the x-ray window 700 are not distorted. The cooling channels 900 can be positioned adjacent to the radiolucent portion 706, and can surround or encircle the radiolucent portion 706, which can improve heat transfer from the radiolucent portion 706.

As illustrated in FIG. 8, the x-ray window 700 can include a multi-layer structure. Similar to other examples, the radiolucent portion 706 can include a first material 800. The first material 800 can be formed from metals, such as aluminum, alumina, titanium, steel, stainless steel, iron, nickel, chrome, copper, beryllium, beryllia, alloys thereof, or the like. The radiopaque portion 708 can include a second material 802. The second material 802 can be formed from metals, such as titanium, steel, stainless steel, iron, nickel, chrome, copper, aluminum, alloys thereof, or the like. The first material 800 can include a material or can be formed with a thickness that allows for greater transmissivity of x-rays relative to the second material 802.

The first material 800 can be bonded to the second material 802 using any of the dissimilar metal-to-metal bonding techniques described herein. For example, the first material 800 can be bonded to the second material 802 using diffusion bonding, explosion bonding, ultrasonic welding, friction welding, or the like. The first material 800 can include a metal that is dissimilar to a metal of the second material 802 and a metal or material of an enclosure to which the x-ray window 700 will be bonded. The second material 802 can be provided to bond the first material 800 to the enclosure and can have a lower transmissivity of x-rays relative to the first material 800. The second material 802 can be bonded to the enclosure of an x-ray tube by a bonding technique for joining similar materials, which may be a conventional bonding technique, such as tig welding, laser welding, conventional welding, or the like.

The cooling channels 900 can be formed in the first material 800 and/or the second material 802. In one or all examples, some surfaces of the cooling channels 900 can be formed in the first material 800 through a subtractive manufacturing technique. The first material 800 can then be bonded to the second material 802, and the second material 802 can define further surfaces of the cooling channels 900. FIGS. 7 through 9 illustrate a single cooling channel 900 that flows through the radiopaque portion 708; however, any number of cooling channels 900 can be provided. Moreover, the cooling channels 900 can have any desired shape (e.g. , the cooling channels 900 can have a square, circular, triangular, or other cross-sectional shape). The cooling channels 900 can be applied to the x-ray window 700 having a round or circular shape or can be applied to any x-ray window having any suitable shape. The cooling channels 900 can encircle or extend around portions of a radiopaque portion of an x-ray window, outside of a radiolucent portion of the x-ray window such that the cooling channels 900 do not distort an image produced by detection of x-rays passing through the x-ray window. In one or all examples, heat transfer from the x-ray window 700 can further be increased by forming carbon nanotubes or other coatings on surfaces of the x-ray window 700.

FIGS. 10 and 11 illustrate views of an x-ray window 1000 including cooling channels 1002. FIG. 10 illustrates a cut-away perspective view and FIG. 11 illustrates a cross-sectional view. The x-ray window 1000 can be used as any of the x-ray windows 214, 302, 402, 600, discussed above with respect to FIGS. 2 through 4 and 6. The x-ray window 1000 can include cooling channels 1002 that flow from an inlet and to an outlet. The x-ray window 1000 can include a radiolucent portion 1004 configured to transmit X rays and a radiopaque portion 1006 configured to block X rays.

FIGS. 10 and 11 illustrate an example in which the cooling channels 1002 flow in the radiolucent portion 1004, between opposite portions of the radiopaque portion 1006. The cooling channels 1002 can extend across (e.g., traverse) an entirety of the radiolucent portion 1004, from edge to edge of the radiolucent portion 1004. In other words, the cooling channels 1002 can extend across the radiolucent portion 1004 from one portion of the radiopaque portion 1006 to an opposite portion of the radiopaque portion 1006, and the cooling channels 1002 can cover or traverse an entire area of the radiolucent portion 1004. The cooling channels 1002 can uniformly span the radiolucent portion 1004 of the x-ray window 1000. In one or all examples, the cooling channels 1002 can attenuate x-rays as they pass through the radiolucent portion 1004 of the x-ray window 1000. In one or all examples, the cooling channels 1002 may or may not extend into the radiopaque portion 1006. By positioning the cooling channels 1002 extending across the radiolucent portion 1004, the cooling channels 1002 impact all of the x-rays that are transmitted through the radiolucent portion 1004 in the same manner. As such, images based on detected X rays that have passed through the x-ray window 1000 are not distorted. The cooling channels 1002 can flow through the radiolucent portion 1004, which can improve heat transfer from the radiolucent portion 1004.

As illustrated in FIG. 10, the x-ray window 1000 can include a multi-layer structure. Similar to other examples, the radiolucent portion 1004 can include a first material 1008. The first material 1008 can be formed from metals, such as aluminum, alumina, titanium, steel, stainless steel, iron, nickel, chrome, copper, beryllium, beryllia, alloys thereof, or the like. The radiopaque portion 1006 can include a second material 1010. The second material 1010 can be formed from metals, such as titanium, steel, stainless steel, iron, nickel, chrome, copper, aluminum, alloys thereof, or the like. The first material 1008 can include a material or can be formed with a thickness that allows for greater transmissivity of x-rays relative to the second material 1010.

The first material 1008 can be bonded to the second material 1010 using any of the dissimilar metal-to-metal bonding techniques described herein. For example, the first material 1008 can be bonded to the second material 1010 using diffusion bonding, explosion bonding, ultrasonic welding, friction welding, or the like. The first material 1008 can include a metal that is dissimilar to a metal of the second material 1010 and a metal or material of an enclosure to which the x-ray window 1000 will be bonded. The second material 1010 can be provided to bond the first material 1008 to the enclosure and can have a lower transmissivity of x-rays relative to the first material 1008. The second material 1010 can be bonded to the enclosure of an x-ray tube by a bonding technique for joining similar materials, which may be a conventional bonding technique, such as tig welding, laser welding, conventional welding, or the like.

The cooling channels 1002 can be formed in the first material 1008 and/or the second material 1010. In the example illustrated in FIGS. 10 and 11, the cooling channels 1002 are formed in the first material 1008. The cooling channels 1002 can be formed by subtracting manufacturing techniques (e.g., milling or the like), can be formed by stacking and bonding layers of the first material 1008, or the like. The cooling channels 1002 can be applied to x-ray windows having any desired shape and can extend completely across a radiolucent portion of the x-ray window in order to avoid distortion of an image produced by detection of x-rays passing through the x-ray window. In one or all examples, heat transfer from the x-ray window 1000 can further be increased by forming carbon nanotubes or other coatings on surfaces of the x-ray window 1000.

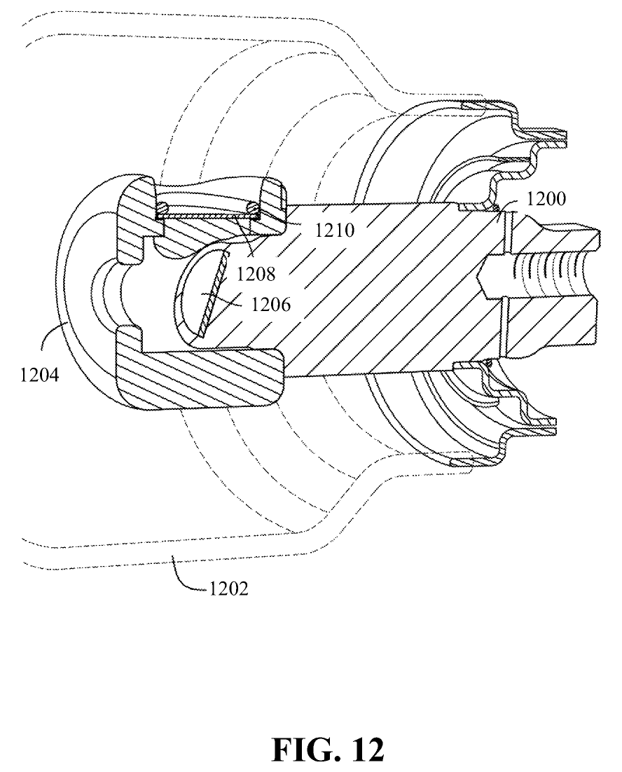

FIG. 12 illustrates a perspective, cutaway view of an anode assembly 1200 and an x-ray tube 1202 that contains the anode assembly 1200. The anode assembly 1200 of FIG. 12 may be an example of a stationary anode and the x-ray tube 1202 may be an example of a single-source x-ray tube. The anode assembly 1200 can include a hood 1204, a target 1206, and a window 1208 secured in the hood 1204 by a retaining ring 1210. The anode assembly 1200 may receive a single stream of electrons emitted from a cathode through the hood 1204 at the target 1206. The stream of electrons may cause a single x-ray beam to be emitted from the target 1206. The x-ray beam may then be transmitted through the window 1208.

The hood 1204 can be configured to retain or contain scattered electrons and x-rays after the stream of electrons hit the target 1206. In one or all examples, the hood 1204 can be formed from any of the previously discussed materials for radiopaque portions. This can include metals, such as steel, stainless steel, titanium, copper; ceramic materials; alumina; or the like.

The window 1208 can be configured to transmit x-rays generated by the anode assembly 1200. In other words, the window 1208 may be radiolucent. The window 1208 can block the transmission of scattered electrons. X-rays may pass through the window 1208 and may then pass through an x-ray window or an enclosure body of the x-ray tube 1202. The window 1208 can be secured within the hood 1204 by the retaining ring 1210. The anode assembly 1200 and the window 1208 can reside within the x-ray tube 1202 such that there is no pressure differential between opposite sides of the window 1208. As such, there is no requirement for a seal (e.g., a hermetic or vacuum seal) to be formed between the window 1208 and the hood 1204 and the window 1208 is non-hermetically coupled to the hood 1204. Thus, the window 1208 can be retained in the hood 1204 by the retaining ring 1210, spot welds, spikes, swaging, brazing, or the like.

The window 1208 can be formed from any of the materials previously discussed for radiolucent portions. For example, the window 1208 can be formed from metals such as aluminum, alumina, titanium, steel, stainless steel, iron, nickel, chrome, copper, beryllium, beryllia, alloys thereof, or the like. In one or all examples, the window 1208 can include non-metal materials, such as diamond, graphite, glass, or the like. In one or all examples, the window 1208 can include a carbon nanotube coating to enhance radiative heat transfer. This can help prevent heat-related issues from damaging the window 1208.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not intended to be exhaustive or to limit the embodiments to the precise forms disclosed. It will be apparent to one of ordinary skill in the art that many modifications and variations are possible in view of the above teachings.

What is claimed is:

1. An x-ray tube comprising:
a cathode;
an anode;
an enclosure body at least partially surrounding the cathode and the anode; and
an x-ray window comprising a radiolucent portion configured to transmit x-rays from the enclosure body, wherein the radiolucent portion is directly bonded to a radiopaque portion of the x-ray window or the enclosure body by metal-to-metal bonds.

2. The x-ray tube of claim 1, wherein the radiolucent portion comprises a first material different from a second material of the radiopaque portion.

3. The x-ray tube of claim 2, wherein the first material comprises aluminum and the second material comprises steel.

4. The x-ray tube of claim 2, wherein:
the enclosure body comprises the second material; and
the radiopaque portion is welded to the enclosure body.

5. The x-ray tube of claim 1, wherein the radiolucent portion curves inwardly relative to the enclosure body.

6. The x-ray tube of claim 1, wherein the x-ray window comprises a carbon nanotube coating on a surface of the x-ray window.

7. The x-ray tube of claim 1, wherein the x-ray window is bonded to the enclosure body by a U-joint formed between the x-ray window and the enclosure body.

8. An x-ray window comprising:
a radiolucent portion;
a radiopaque portion; and
a cooling channel embedded within the x-ray window.

9. The x-ray window of claim 8, wherein the cooling channel traverses an entire area of the radiolucent portion.

10. The x-ray window of claim 8, wherein the cooling channel is disposed in the radiopaque portion.

11. The x-ray window of claim 10, wherein the cooling channel encircles the radiolucent portion.

12. The x-ray window of claim 8, wherein:
the radiolucent portion comprises a first material;
the radiopaque portion comprises a second material different from the first material; and
the cooling channel is defined between the first material and the second material.

13. The x-ray window of claim 8, wherein a first material of the radiolucent portion is bonded to a second material of the radiopaque portion by direct metal-to-metal bonds.

14. The x-ray window of claim 13, wherein the first material is different from the second material.

15. An anode assembly comprising:
a target configured to generate x-rays in response to an electron beam impinging on the target;
a hood configured to contain scattered electrons; and
an x-ray window non-hermetically coupled to the hood.

16. The anode assembly of claim 15, wherein the x-ray window comprises a first material different from a second material of the hood.

17. The anode assembly of claim 16, wherein the first material comprises aluminum, titanium, graphite, copper, alumina, beryllium, beryllia, or diamond.

18. The anode assembly of claim 17, wherein the second material comprises steel, copper, aluminum.

19. The anode assembly of claim 15, wherein the x-ray window is coupled to the hood by a retaining ring.

20. The anode assembly of claim 15, wherein the x-ray window is coupled to the hood by spot welds, spikes, swaging, or brazing.
